(19) United States
(12) Patent Application Publication
(10) Pub. No.: US 2021/0022298 A1
(43) Pub. Date: Jan. 28, 2021

(54) PLANT GROWTH CONTROL METHOD AND PLANT GROW LIGHT SOURCE DEVICE

(71) Applicant: SOLIDLITE CORP., HSINCHU COUNTY (TW)

(72) Inventors: HSING CHEN, HSINCHU COUNTY (TW); WEI-HAO CHEN, HSINGHU COUNTY (TW)

(21) Appl. No.: 16/822,618

(22) Filed: Mar. 18, 2020

(30) Foreign Application Priority Data
Jul. 22, 2019 (TW) 108126086

(51) Int. Cl. A01G 7/04; H05B 45/20; H05B 35/00

(52) U.S. Cl. CPC A01G 7/045; H05B 35/00; H05B 45/20

(57) ABSTRACT

A plant growth control method of the invention includes the following steps: providing a first light during a nursery stage of a plant, wherein the first light has a ratio in photosynthetic photon flux density of R:G:B:NIR:UV of 1.1˜1.5:0.8˜1.7:1:0:0.1˜1; providing a second light during a growth stage of a plant, wherein the second light has a ratio in photosynthetic photon flux density of R:G:B:NIR:UV of 1.2˜4:0.9˜2:1:0.2˜0.6:0˜0.2; and providing a third light in an pre-harvest stage of a plant, wherein the third light has a ratio in photosynthetic photon flux density of R:G:B:NIR:UV of 0.7˜4.9:0.5˜2.1:1:0.2˜0.6:0˜2.

### BACKGROUND OF THE INVENTION

### Field of the Invention

The present invention relates to a technical field of controlling plant growth, and more particularly to a method for controlling plant growth and a light source device for plant growth, which adjusts illumination condition in each stage of plant growth for the requirements of plant growth so that the plant can reach the desired state when harvested.

### Description of the Related Art

The agricultural technology is mostly carried out using artificially constructed cultivation facilities because the cultivation facilities can properly control the growth condition of the plants, and they can provide appropriate protection for the plants during the plant growth process, thereby saving labor and effort and energy.

However, in the case of planting in a cultivation facility, the plant will be excessively long, resulting in a poor appearance and a reduced quality of the plant. The current technical solution for suppressing plant overgrowth is to use chemical control. However the chemical control not only pollutes the environment, but also has the problem of pesticide residues on crops.

The factors required for plant growth mainly depend on photosynthesis. Therefore, to solve the problem of plant overgrowth or other problems, proper adjustment of lighting conditions can also be one of the solutions. The light conditions required by plants in different growing seasons are also different. How to control the degree of light exposure of crops according to the characteristics of crops has really become the key factor for the success of planted crops.

The current plant growth lamps in the prior art are mostly composed of photovoltaic elements (such as light emitting diodes) that can produce a predetermined light color. Such conventional plant growth lamps are designed to simulate full sunlight or high brightness, although it allows users to vary and control lighting conditions such as light source frequency, amplitude, and period ratio according to the type of plant being planted, but the light quality it can provide does not meet the requirements of each stage of plant growth.

Therefore, it is an important topic to introduce the light adjusting means into the cultivation management to prevent the overgrowth of plants, and then to be able to cultivate strong seedlings, as well as to improve plant nutrients and sale.

### BRIEF SUMMARY OF THE INVENTION

An object of the present invention is to provide a plant growth control method. Different light conditions are provided at various stages of plant growth, so that the excessive growth of the plant during the seedling stage are suppressed, the photosynthesis rate during the growth stage are increased for promoting growth, and light adversity is provided to increase secondary metabolites or reduce nitrate content in the early stage of harvest. The plant growth control method of the present invention additionally provides ultraviolet light (UV) and near-infrared light (NIR). Ultraviolet light can inhibit the growth of plants and increase the secondary metabolism of plants. Near-infrared light and red light produce Emerson effect to promote rapid plant growth. The use of different proportions of various light forms to meet the needs at each growth stage of the plant, so that the final crop can meet market requirements.

The present invention provides a plant growth control method. The plant growth control method in accordance with an exemplary embodiment of the invention includes the following steps: providing a first light during a nursery stage of a plant, wherein the first light includes red light, green light, blue light, near-infrared light, and ultraviolet light, and the first light has a ratio in photosynthetic photon flux density of the red light to the green light to the blue light to the near-infrared light to the ultraviolet light of 1.1˜1.5:0.8˜1.7:1:0:0.1˜1; providing a second light during a growth stage of a plant, wherein the second light includes red light, green light, blue light, near-infrared light, and ultraviolet light, and the second light has a ratio in photosynthetic photon flux density of the red light to the green light to the blue light to the near-infrared light to the ultraviolet light of 1.2˜4:0.9˜2:1:0.2˜0.6:0˜0.2; and providing a third light in an pre-harvest stage of a plant, wherein the third light includes red light, green light, blue light, near-infrared light, and ultraviolet light, and the third light has a ratio in photosynthetic photon flux density of the red light to the green light to the blue light to the near-infrared light to the ultraviolet light of 0.7˜4.9:0.5˜2.1:1:0.2˜0.6:0˜2.

In another exemplary embodiment, light energy of the near-infrared light of the second light is less than 10% of overall light energy of the second light.

In yet another exemplary embodiment, light energy of the near-infrared light of the second light is 7% of overall light energy of the second light.

In another exemplary embodiment, light energy of the near-infrared light of the third light is less than 10% of overall light energy of the third light.

In yet another exemplary embodiment, light energy of the near-infrared light of the third light is 7% of overall light energy of the third light.

In another exemplary embodiment, light energy of the ultraviolet light of the first light is greater than or equal to 6% of overall light energy of the first light.

In yet another exemplary embodiment, light energy of the ultraviolet light of the first light is 9% of overall light energy of the first light.

In another exemplary embodiment, light energy of the ultraviolet light of the second light is less than or equal to 6% of overall light energy of the second light.

In yet another exemplary embodiment, light energy of the ultraviolet light of the third light ranges from 6% to 15% of total light energy of the third light.

In another exemplary embodiment, light energy of the ultraviolet light of the third light is 12% of total light energy of the third light.

In yet another exemplary embodiment, the first light has photosynthetic photon fluxes of density greater than 200 μmol/m²/s.

In another exemplary embodiment, the second light has photosynthetic photon fluxes of density greater than 200 μmol/m²/s.

In yet another exemplary embodiment, the third light has photosynthetic photon fluxes of density greater than 200 μmol/m²/s.

The present invention provides a plant growth light source device including a first light source emitting red light, green light, and blue light of visible light; a second light source emitting near-infrared light; and a third light source emitting ultraviolet light; wherein the red light, the green light, and the blue light emitted by the first light source, the near-infrared light emitted by the second light source, and the ultraviolet light emitted by the third light source are mixed to form the first light, the second light and the third light as used in the plant growth control method.

In another exemplary embodiment, the first light source includes a light emitting diode emitting white light.

In yet another exemplary embodiment, the first light source comprises a plurality of monochrome light-emitting diodes emitting emit red light, green light, or blue light respectively.

In another exemplary embodiment, the second light source comprises a light emitting diode emitting near-infrared light.

In yet another exemplary embodiment, the second light source comprises a light emitting diode emitting near-infrared light.

In another exemplary embodiment, the third light source comprises a light emitting diode emitting ultraviolet light.

In yet another exemplary embodiment, the third light source comprises a light tube emitting ultraviolet light.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of a plant growth control method of the present invention;

FIG. 2 is a diagram of an optical spectrum of the light for a nursery stage of the plant growth of the plant growth control method of the present invention;

FIG. 3 is a diagram of an optical spectrum of the light for a growth stage of the plant growth of the plant growth control method of the present invention;

FIG. 4 is a diagram of an optical spectrum of the light for an pre-harvest stage of the plant growth of the plant growth control method of the present invention;

FIG. 5 is a schematic view of an arrangement of light emitting diodes of a plant growth light source device of the present invention; and

FIG. 6 is a schematic view of an arrangement of plant growth lamps of the plant growth light source device of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

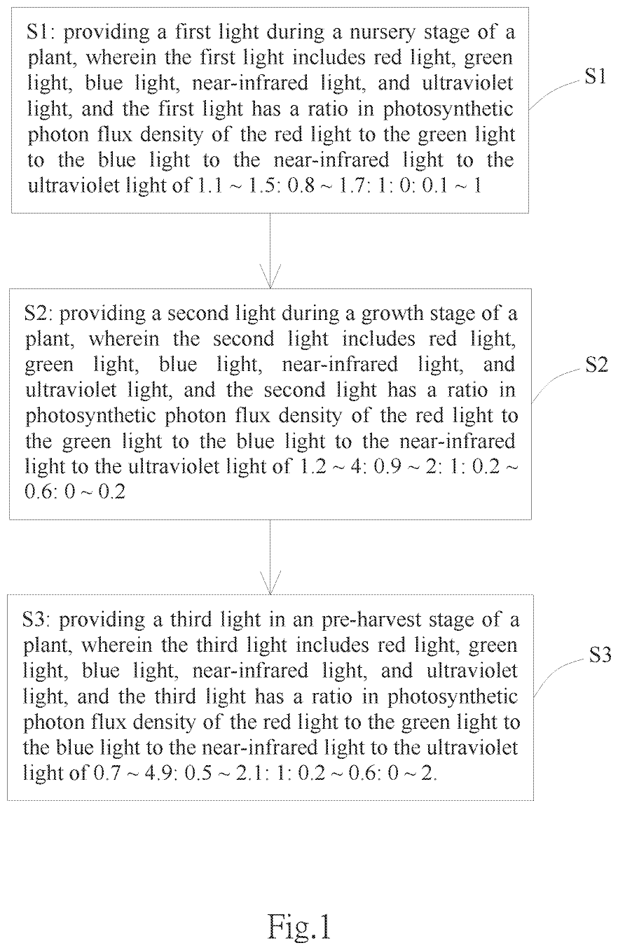

Please refer to FIG. 1, which illustrates an embodiment of the plant growth control method of the present invention. In step S1, a first light is provided during the nursery stage of the plant, the first light includes red light, green light, blue light, and ultraviolet light, and the first light is red light, green light, blue light, near-infrared light, and ultraviolet light. The ratio of the photosynthetic photon flux density of the red light, green light, the blue light, the near-infrared light, and the ultraviolet light is 1.1˜1.5:0.8˜1.7:1:0:0.1˜1.

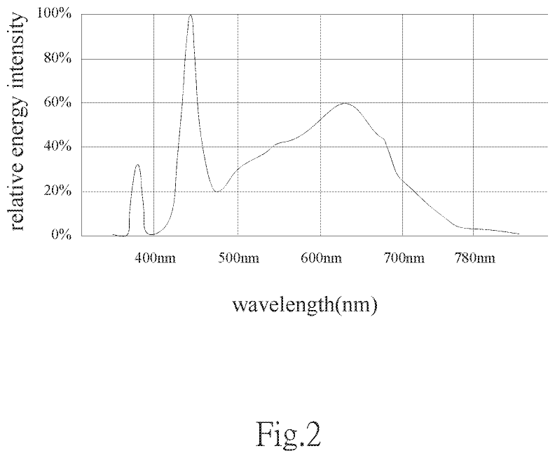

Please refer to FIG. 2, which illustrates an optical spectrum of light for the nursery stage of the plant used in the plant growth control method of the present invention. The visible red, green and blue light provide the photosynthesis needed for plant growth. Ultraviolet light can suppress the growth of plants. The first light is provided during the nursery stage of the plant effectively to suppress excessive growth of the plant at the nursery stage, and help plants become healthy seedlings. The light energy of the ultraviolet light of the first light is greater than or equal to 6% of the total light energy of the first light, and the light energy of the ultraviolet light of the first light is preferably 9% of the total light energy of the first light. In addition, the value of the photosynthetic photon flux density (PPFD) of the first light is greater than 200 μmol/m² s. represents the light quantum number in the visible light wavelength range per unit time and area. That is, the visible light, in the wavelength range of 400 to 700 nm, such as the red light, the green light, and the blue light, which represents the effective light amount of photosynthesis for plant growth during the nursery stage. The photosynthetic photon flux density of red light is 58 to 73; the photosynthetic photon flux density of green light is 53 to 66; the photosynthetic photon flux density of blue light is 38 to 67; the photosynthetic photon flux density of ultraviolet light is 7 to 38. In addition, in order to avoid overgrowth of plant, NIR light is not provided during the nursery stage. During the nursery stage, visible light and ultraviolet light are irradiated for 10 to 12 hours each day.

The ration of photosynthetic photon flux density for the red light (R), the green light (G), the blue light (B), the near infrared light (NIR) and the ultraviolet light (UV) V is calculated by measuring the photosynthetic photon flux density (PPFD) of R:G:B:NIR:UV under the same light source. If the PPFD (u-mol/m²/s) of the red light (wavelength of 600˜699 nm) is 170, the PPFD (u-mol/m²/s) of the green light (wavelength of 500˜599 nm) is 150, the PPFD (u-mol/m²/s) of the blue light (wavelength of 400˜499 nm) is 100, the PPFD (u-mol/m²/s) of the near infrared light (NIR)(wavelength of 701˜780 nm) is 50, the PPFD (u-mol/m²/s) of the ultraviolet light (UV) (wavelength of less than 400 nm) is 80, the PPFD values of the red light, the green light, the blue light, the near infrared light and the ultraviolet light are divided by the PPFD value of the blue light respectively (the denominator is 100), then the ratio of PPFD value of the red light (R): the green light (G): the blue light (B): the near infrared light (NIR): the ultraviolet light (UV) is 1.7:1.5:1:0.5:0.8.

In addition, the EC value of the nutrient solution concentration in the plant nursery stage is controlled at 0.4 to 1.5 mS/cm. The aforementioned ratio can effectively inhibit the overgrowth of plants at the nursery stage, and help plants become healthy seedlings.

When the plant's nursery stage ends, the plant begins to enter the growth stage. At this time, the plant growth control method of the present invention enters step S2.

Please refer to FIG. 1 again. In step S2, a second light is provided during the growth stage of the plant. The second light includes red light, green light, blue light, near-infrared light, and ultraviolet light. The ratio of the photosynthetic photon flux density of the red light, green light, the blue light, the near-infrared light, and the ultraviolet light is 1.2˜4:0.9˜2:1:0.2˜0.6:0˜0.2. A near-infrared light with a wavelength of 701 nm to 780 nm is provided during the growth period of a plant to speed the plant growth.

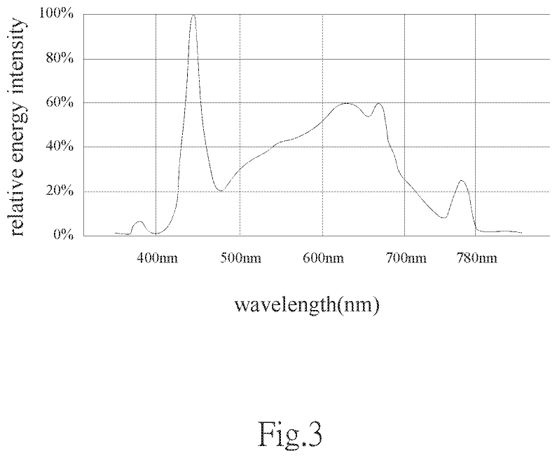

Please refer to FIG. 3, which illustrates an optical spectrum of light for the growth stage of the plant used in the plant growth control method of the present invention. The light energy of the near-infrared light of the second light is less than 10% of the overall light energy of the second light, and the light energy of the near-infrared light of the second light is preferably 7% of the overall light energy of the second light. The light energy of the ultraviolet light of the second light is less than or equal to 6% of the total light energy of the first light. The value of PPFD of the second light is greater than 200 μmol/m2/s. In the nursery stage, the PPFD of red light is 73 to 103; the PPFD of green light is 51 to 55; the PPFD of blue light is 26 to 60; the PPFD of near-infrared light is 12 to 15; the PPFD of ultraviolet light is 0 to 5. The EC value of the nutrient solution during the growth period is controlled at 1.5˜2.0 mS/cm. The aforementioned ratio can effectively promote the photosynthesis rate of plant, and help plants grow quickly. During the growth stage, visible light, near infrared light, and ultraviolet light are irradiated for 10 to 12 hours each day.

When the growth period of the plant is completed, the plant begins to enter the pre-harvest stage, and the plant growth control method of the present invention proceeds to step S3.

Please refer to FIG. 1 again. In step S3, a third light is provided in the pre-harvest stage of the plant. The third light includes red light, green light, blue light, near infrared light, and ultraviolet light. The ratio of the photosynthetic photon flux density of the red light, green light, the blue light, the near-infrared light, and the ultraviolet light is 0.7˜4.9:0.5˜2.1:1:0.2˜0.6:0˜2.

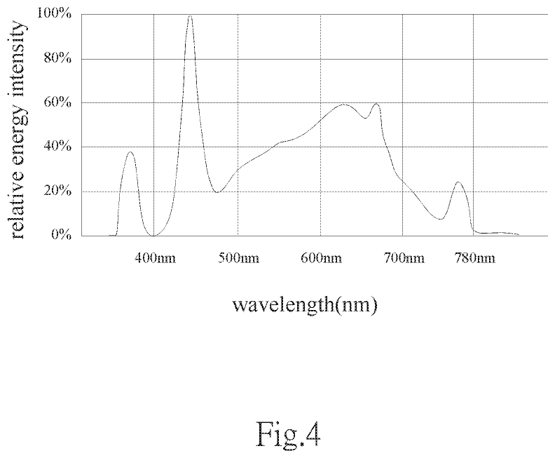

Please refer to FIG. 4, which illustrates an optical spectrum of light for the pre-harvest stage of the plant used in the plant growth control method of the present invention. The light energy of the near-infrared light of the third light is less than or equal to 10% of the total light energy of the third light. The light energy ratio of the near-infrared light of the third light is preferably 7% of the overall light energy of the third light. The light energy of the ultraviolet light of the third light is 6% to 15% of the total light energy of the third light. The light energy ratio of the ultraviolet light of the third light is preferably 12% of the total light energy of the third light. The value of PPFD of the third light is greater than 200/m²/s. In the nursery stage, the PPFD value of the red light is 73 to 115; the PPFD value of the green light is 50 to 52; the PPFD of the blue light is 24 to 104; the PPFD value of the near-infrared light is 14 to 21; the PPFD value of the ultraviolet light is 0 to 47. The EC value of the nutrient solution concentration in the pre-harvest stage is controlled at 0˜1.5 mS/cm. At the aforementioned ratio, it can effectively promote the formation of secondary metabolites, or help plants reduce the accumulation of harmful substances such as nitrate content. In the pre-harvest stage, the visible light, the near-infrared light and the ultraviolet light are irradiated for 18 to 24 hours every day.

The following Table 1 shows a list of the technical means provided in the aforementioned steps S1 to S3 for the nursery stage, the growth stage and the pre-harvest stage of the plant growth and the problems to be solved by the technical means.

TABLE

| | Problem to | |
|---|---|---|
| | be solved | Technical Means |
| nursery | 1. to be a healthy | R:G:B:NIR:UV = |
| stage | seedling | 1.1~1.5:0.8~1.7:1:0:0.1~1 |
| | 2. prevent | UV (wavelength less than 400 nm) at |
| | overgrowth | least 6% and preferably 9% |
| growth | 1. speed growth | R:G:B:NIR:UV = |
| stage | 2. to have good | 1.2~4:09~2:1:0.2~0.6:0~0.2 |
| | appearance | NIR (wavelength less than 701~780 |
| | 3. increase | nm) at most 10% and preferably 7% |
| | photosynthesis rate | |
| pre- | 1. Reduce nitrate | R:G:B:NIR:UV = |
| harvest | 2. Increase | 0.7~4.9:0.5~2.1:1:0.2~0.6:0~2 |
| stage | secondary metabolism | UV (wavelength less than 400 nm) at |
| | 3. Increase nutrient | least 6~15% and preferably 12% |
| | production | NIR (wavelength less than 701~780 |
| | (Increased anthocyanin | nm) at most 10% and preferably 7% |
| | content/improved | |
| | ginseng efficacy) | |

In addition, Table 2 below shows a comparison of the crops grown by the conventional plant growth control method and the plant growth control method of the present invention.

TABLE 2

| | The conventional plant | The plant growth method |
|---|---|---|
| | growth method | of the invention |
| light condition | red light + green light + | red light + green light + |
| | blue light (RGB) | blue light + UV + NIR |
| | | (RGB + UV + NIR) |
| seedling index | 0.7 | 0.96 |
| fresh weight(g)/ | 63 g | 76 g |
| each plant | | |
| color | light color | dark color |

As shown in Table 2, the crops grown by the plant growth control method of the present invention have a high seedling index and a large weight.

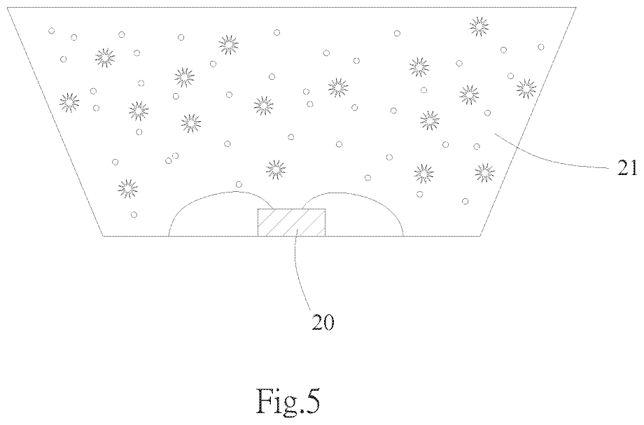

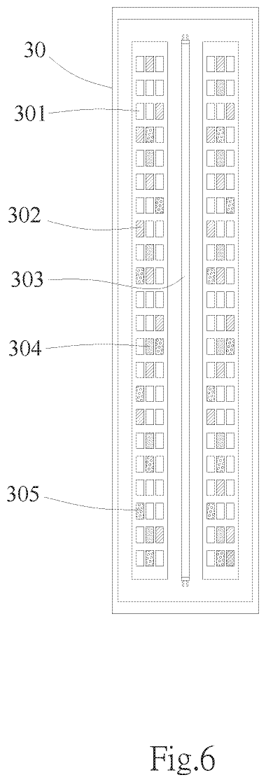

Please refer to FIG. 5 and FIG. 6. As shown in FIG. 6, the plant growth light source device 30 of the present invention includes a first light source 301, a second light source 304, and third light sources 302 and 303. The first light source 301 is a light emitting diode that emits white light. The second light source 304 is a light emitting diode that emits near-infrared light. The third light source 302 is a light emitting diode that emits ultraviolet light. The third light source 303 is disposed in the center of the plant growth light source device 30 and is an ultraviolet light tube that emits ultraviolet light. The plant growth light source device 30 of the present invention further includes a light emitting diode 305 that emits red light. White LED 301 and additional UV LED 302 or UV fluorescent tube 303 or NIR LED 304 or monochrome red LED 305 are added to achieve the required ratio.

In addition to the various light emitting diodes that emit monochromatic light as shown in FIG. 6, FIG. 5 illustrates a monochromatic light emitting chip 20 can be used to excite the mixed phosphor 21 to emit the light having the required PPFD ratio of the red light, green light, the blue light, the near-infrared light, and the ultraviolet light.

In addition to the plant growth control method disclosed in the present invention, in addition to effectively suppress the growth of the plant during the nursery stage of the plant, and helping the plant become a healthy seedling, the root development of the plant can be healthier during the planting period. In the early stage of planting, it can make the roots of plants healthier, promote the development of plant roots, and can absorb more nutrients and grow relatively well. During the growth stage of plants, it can speed the growth of plants and increase the photosynthesis of plants to obtain a relatively good appearance. In the pre-harvest stages of plant, it can reduce the nitrate content, increase the secondary metabolism, and increase the production of plant nutrients. Therefore, it can increase the productivity and quality of plants by relatively more positive and reliable means.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A plant growth control method, comprising:
providing a first light during a nursery stage of a plant, wherein the first light includes red light, green light, blue light, near-infrared light, and ultraviolet light, and the first light has a ratio in photosynthetic photon flux density of the red light to the green light to the blue light to the near-infrared light to the ultraviolet light of 1.1˜1.5:0.8˜1.7:1:0:0.1˜1;
providing a second light during a growth stage of a plant, wherein the second light includes red light, green light, blue light, near-infrared light, and ultraviolet light, and the second light has a ratio in photosynthetic photon flux density of the red light to the green light to the blue light to the near-infrared light to the ultraviolet light of 1.2˜4:0.9˜2:1:0.2˜0.6:0˜0.2; and
providing a third light in an pre-harvest stage of a plant, wherein the third light includes red light, green light, blue light, near-infrared light, and ultraviolet light, and the third light has a ratio in photosynthetic photon flux density of the red light to the green light to the blue light to the near-infrared light to the ultraviolet light of 0.7˜4.9:0.5˜2.1:1:0.2 0.6:0˜2.

2. The plant growth control method as claimed in claim 1, wherein light energy of the near-infrared light of the second light is less than 10% of overall light energy of the second light.

3. The plant growth control method as claimed in claim 2, wherein light energy of the near-infrared light of the second light is 7% of overall light energy of the second light.

4. The plant growth control method as claimed in claim 3, wherein light energy of the near-infrared light of the third light is less than 10% of overall light energy of the third light.

5. The plant growth control method as claimed in claim 4, wherein light energy of the near-infrared light of the third light is 7% of overall light energy of the third light.

6. The plant growth control method as claimed in claim 1, wherein light energy of the ultraviolet light of the first light is greater than or equal to 6% of overall light energy of the first light.

7. The plant growth control method as claimed in claim 6, wherein light energy of the ultraviolet light of the first light is 9% of overall light energy of the first light.

8. The plant growth control method as claimed in claim 1, wherein light energy of the ultraviolet light of the second light is less than or equal to 6% of overall light energy of the second light.

9. The plant growth control method as claimed in claim 1, wherein light energy of the ultraviolet light of the third light ranges from 6% to 15% of total light energy of the third light.

10. The plant growth control method as claimed in claim 9, wherein light energy of the ultraviolet light of the third light is 12% of total light energy of the third light.

11. The plant growth control method as claimed in claim 1, wherein the first light has photosynthetic photon fluxes of density greater than 200 μ-mol/m²/s.

12. The plant growth control method as claimed in claim 1, wherein the second light has photosynthetic photon fluxes of density greater than 200 μ-mol/m²/s.

13. The plant growth control method as claimed in claim 1, wherein the third light has photosynthetic photon fluxes of density greater than 200 μ-mol/m²/s.

14. A plant growth light source device, comprising:
a first light source emitting red light, green light, and blue light of visible light;
a second light source emitting near-infrared light; and
a third light source emitting ultraviolet light;
wherein the red light, the green light, and the blue light emitted by the first light source, the near-infrared light emitted by the second light source, and the ultraviolet light emitted by the third light source are mixed to form the first light, the second light and the third light as claimed in claim 1.

15. The plant growth light source device as claimed in claim 14, wherein the first light source comprises a light emitting diode emitting white light.

16. The plant growth light source device as claimed in claim 14, wherein the first light source comprises a plurality of monochrome light-emitting diodes emitting emit red light, green light, or blue light respectively.

17. The plant growth light source device as claimed in claim 14, wherein the second light source comprises a light emitting diode emitting near-infrared light.

18. The plant growth light source device as claimed in claim 14, wherein the third light source comprises a light emitting diode emitting ultraviolet light.

19. The plant growth light source device as claimed in claim 14, wherein the third light source comprises a light tube emitting ultraviolet light.
